(19) United States
(12) Patent Application Publication
(10) Pub. No.: US 2011/0234774 A1
(43) Pub. Date: Sep. 29, 2011

(54) Shutter glasses and method of obtaining shutter control signal of shutter glasses

(75) Inventors: Yoshinori Satoh, Saitama (JP); Takashi Tsurumoto, Saitama (JP); Kazunori Kikuchi, Kanagawa (JP)

(73) Assignee: Sony Corporation, Tokyo (JP)

(21) Appl. No.: 12/932,741

(22) Filed: Mar. 4, 2011

(30) Foreign Application Priority Data
Mar. 24, 2010 (JP) P2010-068705

(51) Int. Cl. H04N 13/04

(52) U.S. Cl. 348/56; 348/E13.059

(57) ABSTRACT

A pair of shutter glasses includes a shutter glasses unit having a right eye shutter and a left eye shutter, a wireless communication unit performing a wireless communication with an image display device, a shutter driving unit opening and closing the left eye shutter and the right eye shutter of the shutter glasses unit, a glasses state obtaining unit obtaining glasses state information by detecting one or both of the position and the direction of the shutter glasses unit, a storage unit holding a combination of the glasses state information and network address information of the image display device, and a control unit controlling the wireless communication unit to perform the wireless communication with a predetermined image display device using the network address information contained in the combination, and to obtain the shutter control signal from the predetermined image display device accordingly.

### CROSS-REFERENCE TO RELATED APPLICATION

The present application claims priority from Japanese Patent Application No. JP 2010-068705 filed in the Japanese Patent Office on Mar. 24, 2010, the entire content of which is incorporated herein by reference.

### BACKGROUND OF THE INVENTION

1. Field of the Invention

The present invention relates to a pair of shutter glasses and a method of obtaining a shutter control signal of the shutter glasses. Particularly, the invention relates to shutter glasses obtaining shutter control signal by performing wireless communication with an image display device.

2. Description of the Related Art

In the related art, as a display method of a three-dimensional image, a shutter glasses method is known. In the shutter glasses method, a left eye image and a right eye image having parallax are alternatively displayed in an image display device, and observed through the shutter glasses, whereby an observer perceives the three-dimensional image (refer to Japanese Unexamined Patent Application Publication Nos. 09-138384, 2000-036969, and 2003-045343, for example).

### SUMMARY OF THE INVENTION

As a method of notifying a pair of shutter glasses of a shutter control signal generated from the image display device to control the opening and closing of shutter glasses, there is an infrared method (IR) using infrared rays. The infrared method has problems of interference and directivity caused between other systems and the infrared rays.

In this context, a wireless method (RF method) is considered. In the wireless method, a shutter control signal generated from the image display device to control the opening and closing of shutter glasses is notified to the shutter glasses by a wireless communication, and the problems of interference and directivity caused between other systems and the infrared rays can be resolved.

In the wireless method, the shutters of the shutter glasses are controlled in synchronization with a specific image display device. Therefore, when there is a plurality of image display devices, if a user turns their gaze off the specific image display device to another image display device, it is necessary for the user to select and switch the image display device themselves since the shutters are still continuously controlled in synchronization with the specific image display device. When the user turns away their gaze from the specific image display device, since the shutters are still continuously controlled in synchronization with the specific image display device, it is difficult for the user to see objects around them.

It is desirable to improve the usability of a pair of shutter glasses obtaining a shutter control signal by performing wireless communication with an image display device.

According to an embodiment of the invention, there is provided a pair of shutter glasses including: a shutter glasses unit having a left eye shutter and a right eye shutter; a wireless communication unit performing wireless communication with an image display device carrying out a time-sharing display of a left eye image and a right eye image in a predetermined period; a shutter driving unit opening and closing the left eye shutter and the right eye shutter of the shutter glasses unit based on the shutter control signal obtained from the image display device by the wireless communication unit; a glasses state obtaining unit obtaining state information by detecting one or both of the position and the direction of the shutter glasses unit as a glasses state; a storage unit holding a combination of the glasses state information and network address information of the image display device; and a control unit causing the wireless communication unit, when the storage unit has a combination containing glasses state information corresponding to the glasses state information which is obtained by the glasses state obtaining unit, to perform the wireless communication with a predetermined image display device using the network address information contained in the combination, and to obtain the shutter control signal from the predetermined image display device accordingly.

In the invention, the wireless communication unit performs the wireless communication with the image display device, thereby obtaining the shutter control signal. Also, the shutter driving unit opens and closes the left eye shutter and the right eye shutter of the shutter glasses unit, based on the shutter control signal. Therefore, it is possible for a user (observer) to observe only the left eye image through the left eye shutter, and to observe only the right eye image through the right eye shutter. The user can perceive a three-dimensional image in this manner.

The glasses state obtaining unit detects one or both of the position and the direction of the shutter glasses unit as a glasses state, thereby obtaining the glasses state information. The storage unit holds the combination of the glasses state information and the network address information of the image display device. Also, the control unit controls the obtainment of the shutter control signal performed in the wireless communication unit, based on the glasses state information obtained by the glasses state obtaining unit and the information held in the storage unit.

When the storage unit has a combination containing glasses state information corresponding to the glasses state information which is obtained by the glasses state obtaining unit, the wireless communication unit performs the wireless communication with a predetermined image display device using the network address information contained in the combination, and obtains the shutter control signal from the predetermined image display device.

In this manner, in the invention, an image display device from which the shutter control signal is supposed to be obtained is specified, based on the glasses state (positional and directional state) of the shutter glasses. Accordingly, when there is a plurality of image display devices, if a user turns their gaze off the specific image display device to another image display device, according to the change in the glasses state of the shutter glasses unit, another image display device is automatically specified as the image display device from which the shutter control signal is supposed to be obtained, and the shutter control signal is obtained from the other image display device. Therefore, it is not necessary for the user to select and switch the image display device themselves, whereby the usability is improved.

For instance, in the invention, the glasses state obtaining unit may detect one or both of the position and the direction of the shutter glasses unit as a glasses state to obtain the positional information and the directional information, and the storage unit may hold a combination of the positional and directional information and the network address information. In addition, when the storage unit has a predetermined number of combinations containing the positional information within a predetermined threshold range with respect to the positional information obtained by the glasses state obtaining unit, the control unit may control the wireless communication unit to perform the wireless communication with a predetermined image display device, using the network address information contained in a combination containing the directional information closest to the directional information obtained by the glasses state obtaining unit, among the predetermined number of combinations, and to obtain the shutter control signal from the predetermined image display device accordingly.

Furthermore, in the invention, for example, the storage unit may include a registration unit holding a combination of glasses information and the network address information. The registration unit may have a user operation unit for the user to perform a registration operation. When the registration operation is performed in the user operation unit, the registration unit may cause the wireless communication unit to transmit a discovery command to all the image display devices finished with pairing, and to receive a discovery response from a predetermined image display device, in response to the transmission of the discovery command. Through the operation, the registration unit may cause the storage unit to hold the combination of the network address information of the predetermined image display device contained in the discovery response and the glasses state information obtained by the glasses state obtaining unit.

In the invention, for example, when the storage unit does not have the combination containing the glasses information corresponding to the glasses state obtained by the glasses state obtaining unit, the control unit may control the shutter driving unit to make a completely open state where both the left eye shutter and the right eye shutter of the shutter glasses are opened. In this case, when a user turns away their gaze from the predetermined image display device, the shutter is not continuously controlled in synchronization with the predetermined image display device any longer, and both the left eye shutter and the right eye shutter are opened. Therefore, the user can easily see objects around them.

In the invention, for example, the glasses state obtaining unit may detect both the position and the direction of the shutter glasses unit as a glasses state to obtain the positional information and the directional information, and the storage unit may hold the combination of the positional and directional information and the network address information. Also, when the storage unit does not have a combination containing the positional information within a predetermined threshold range with respect to the positional information obtained by the glasses state obtaining unit, the control unit may control the shutter driving unit to make a completely open state where both the left eye shutter and the right eye shutter of the shutter glasses are opened.

In the invention, for example, the wireless communication unit may have an opening/closing counter used for opening and closing the left eye shutter and the right eye shutter of the shutter glasses unit, request the image display device for the synchronization of clock frequency, match the value of the opening/closing counter with the value of a counter in the image display device, which is counted by the synchronized clock frequency, and periodically receives a shutter opening/closing timing from the image display device as the shutter control signal, in response to the value of the opening/closing counter.

According to the invention, an image display device from which the shutter control signal is supposed to be obtained is specified, based on the glasses state (positional and directional state) of the shutter glasses unit. Accordingly, it is not necessary for the user to select and switch the image display device themselves, whereby the usability is improved. In addition, when the user turns away their gaze from the specific image display device, since both the left eye shutter and the right eye shutter are completely opened, the user can easily see objects around them, whereby the usability is improved.

### BRIEF DESCRIPTION OF THE DRAWINGS

FIG. 1 is a block diagram showing a configuration example of an image display observation system as a first embodiment of the invention.

FIG. 2 is a block diagram showing a configuration example of an image display device constituting the image display observation system.

FIG. 3 is a block diagram showing a configuration example of a pair of shutter glasses constituting the image display observation system.

FIG. 4 is a diagram showing an example of a registration sequence for holding a combination of the positional information and the directional information and the network address information of the image display device, into a storage unit.

FIG. 5 is a diagram showing an example of information management performed by the storage unit.

FIG. 6 is a flowchart showing an example of a procedure in a controlling process performed by a control unit to obtain a shutter control signal.

FIG. 7 is a block diagram showing a configuration example of a transmission system of the shutter control signal contained in the image display device, and a reception system of the shutter control signal contained in a pair of shutter glasses.

FIG. 8 is a block diagram illustrating the configuration of a transmission system and a reception system of the shutter control signal.

FIG. 9 is a diagram illustrating a series of operations performed between the image display device and a pair of shutter glasses.

FIG. 10 is a diagram showing an example of an opening/closing timing of a left eye shutter and a right eye shutter of a pair of shutter glasses.

FIG. 11 is a flowchart showing a series of operations performed between the image display device and a pair of shutter glasses.

FIG. 12 is a sequence diagram illustrating a series of operations performed between the image display device and a pair of shutter glasses.

FIG. 13 is a block diagram showing a configuration example of an image display observation system as a second embodiment of the invention.

FIG. 14 is a diagram showing an example of a registration sequence for holding a combination of the positional information and the directional information and the network address information of the image display device, into the storage unit.

FIG. 15 is a diagram showing an example of information management performed by the storage unit.

FIG. 16 is a flowchart showing an example of a sequence in a controlling process performed by a control unit to obtain the shutter control signal.

FIG. 17 is a flowchart showing another example of a sequence in a controlling process performed by a control unit to obtain the shutter control signal.

FIG. 18 is a flowchart showing another example of a sequence in a controlling process performed by a control unit to obtain the shutter control signal.

### DESCRIPTION OF THE PREFERRED EMBODIMENTS

Hereinbelow, the preferred embodiments of the invention (referred to as “embodiment” hereinafter) will be described. The description will be made in the following sequence.
1. A First Embodiment
2. A Second Embodiment
3. Modification

### 1. A First Embodiment

### [Configuration Example of Image Display Observation System]

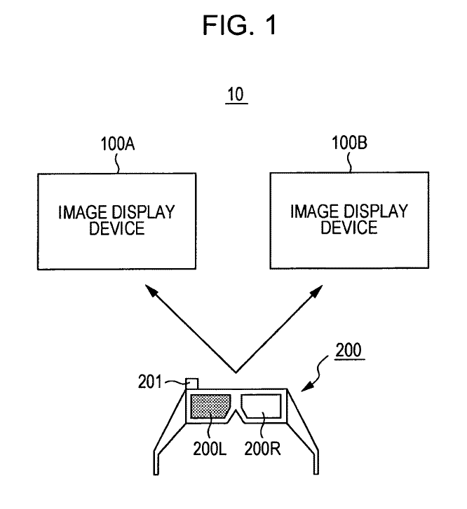

FIG. 1 shows a configuration example of an image display observation system 10 as a First Embodiment. The image display observation system 10 includes image display devices 100A and 100B, and a pair of shutter glasses 200. The image display devices 100A and 100B display a left eye image and a right eye image having parallax in a time-sharing manner with a predetermined period. The shutter glasses 200 include a position/direction sensor 201. The position/direction sensor 201 detects the position of a pair of shutter glasses 200, and obtains the positional and directional information as the glasses state information.

In relation to the image display observation system 10 shown in FIG. 1, a case where a user (observer) wears the shutter glasses 200 and observes the image display device 100A will be described. In this case, based on the positional information and the directional information obtained by the position/direction sensor 201, the shutter glasses 200 perform the wireless communication with the image display device 100A, and obtain the shutter control signal from the image display device 100A.

Based on the shutter control signal, the left eye shutter 200L and the right eye shutter 200R of the shutter glasses 200 are opened and closed according to the display of a left eye image and a right eye image of the image display device 100A. In the shutter glasses 200, the left eye shutter 200L is opened at the timing when the left eye image is displayed on the image display device 100A, and the right eye shutter 200R is opened at the timing when the right eye image is displayed on the image display device 100A. Therefore, the user can perceive only the left eye image with the left eye and only the right eye image with the right eye. Based on the left eye image and the right eye image having parallax displayed on the image display device 100A, the user can perceive a three-dimensional image.

In relation to the image display observation system 10 shown in FIG. 1, a case where the user (observer) wears the shutter glasses 200, and sees the display image of the image display device 100B will be described. In this case, based on the positional information and the directional information obtained by the position/direction sensor 201, the shutter glasses 200 perform the wireless communication with the image display device 100B, and obtain the shutter control signal from the image display device 100B.

Based on the shutter control signal, the left eye shutter 200L and the right eye shutter 200R of the shutter glasses 200 are opened and closed according to the display of the left eye image and the right eye image of the image display device 100B. In the shutter glasses 200, the left eye shutter 200L is opened at the timing when the left eye image is displayed on the image display device 100B, and the right eye shutter 200R is opened at the timing when the right eye image is displayed on the image display device 100B. Therefore, the user can perceive only the left eye image with the left eye and only the right eye image with the right eye. Based on the left eye image and the right eye image having parallax displayed on the image display device 100B, the user can perceive the three-dimensional image.

### [Configuration of Image Display Device]

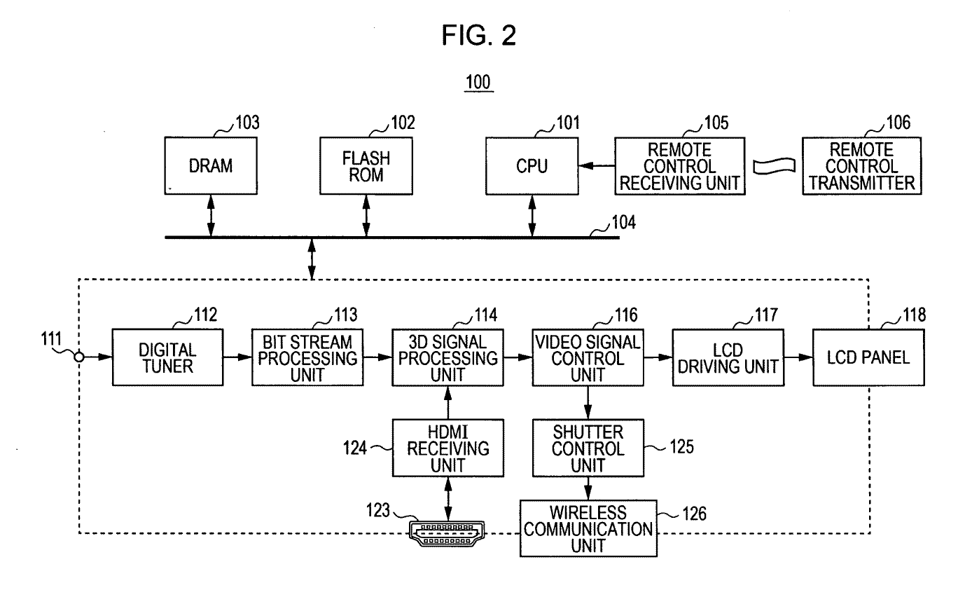

The image display device 100 (100A and 100B) will be described. FIG. 2 shows a configuration example of the image display device 100. The image display device 100 includes a CPU 101, a flash ROM 102, a DRAM 103, an internal bus 104, a remote control receiving unit 105, and a remote control transmitter 106. The image display device 100 also includes an antenna terminal 111, a digital tuner 112, a bit stream processing unit 113, a 3D signal processing unit 114, and a video signal control unit 116. The image display device 100 further includes an LCD (Liquid Crystal Display) driving unit 117, an LCD panel 118, an HDMI terminal 123, an HDMI receiving unit 124, a shutter control unit 125, and a wireless communication unit 126.

The CPU 101 controls the operation of the respective units in the image display device 100. The flash ROM 102 stores a control software and keeps data. The DRAM 103 constitutes the work area of the CPU 101. The CPU 101 expands the software and data read from the flash ROM 102 on the DRAM 103, activates the software, and controls the respective units in the image display device 100.

The remote control receiving unit 105 receives a remote control signal (remote control code) transmitted from the remote control transmitter 106, and supplies the signal to the CPU 101. Based on the remote control code, the CPU 101 controls the respective units in the image display device 100. The CPU 101, the flash ROM 102, and the DRAM 103 are interconnected by the internal bus 104.

The antenna terminal 111 is a terminal to which a television broadcast signal received by a receiving antenna (not shown) is input. The digital tuner 112 processes the television broadcast signal input to the antenna terminal 111, and outputs predetermined bit stream data corresponding to the channel selected by the user. The bit stream processing unit 113 extracts the image data or audio data from the bit stream data, as the contents data.

By the communication performed based on the HDMI (High Definition Multimedia Interface), the HDMI receiving unit 124 receives the non-compressed three-dimensional image data and the audio data supplied to the HDMI terminal 123. The HDMI terminal 123 is connected to, for example, HDMI source devices such as a disk recorder, a disk player, a set top box, or a game machine, through an HDMI cable. The image display device 100 is an HDMI sync device.

The 3D signal processing unit 114 performs a decoding process on the three-dimensional image data received by the HDMI receiving unit 124 or obtained by the bit stream processing unit 113, according to the transmission method, sequentially obtains the left eye image data and the right eye image data in respective frames, and outputs the data. As the transmission method of the three-dimensional image data in the television broadcast signal, there are methods such as a “Top & Bottom” method, a “Side By Side” method, and a “Frame Sequential” method as examples. In addition, as the TMDS transmission data structure (3D Video Format) of the three-dimensional image data in the HDMI, there are methods such as a “Frame packing” method, a “Line alternative” method, and a “Side-By-Side” method as examples.

Based on the left eye image data and the right eye image data in respective frames output from the 3D signal processing unit 114, the video signal control unit 116 generates the image data for displaying the three-dimensional image. That is, the video signal control unit 116 generates the image data to display images on the LCD panel 118 in the time-sharing manner with a sequence of the left eye image→the right eye image→the left eye image→the right eye image→ . . . . At this time, the left eye image and the right eye image are repeatedly displayed respectively by a plurality of frames in some cases. In this case, the video signal control unit 116 generates the image data to display images with a sequence of the right eye image→the left eye image→the left eye image→the right eye image→the right eye image→ . . . for example.

The video signal control unit 116 outputs image data thus generated to the LCD driving unit 117. Based on the image data generated from the video signal control unit 116, the LCD driving unit 117 drives the LCD panel 118, and displays the left eye image and the right eye image having parallax, on the LCD panel 118 in the time-sharing manner with a predetermined period.

The shutter control unit 125 receives a predetermined transmitted signal generated based on the signal process performed in the video signal control unit 116, and according to this signal, the shutter control unit 125 generates a shutter control signal controlling the shutter operation of the shutter glasses 200. The wireless communication unit 126 performs the wireless communication with the shutter glasses 200, based on the IEEE802.15.4 for example. The wireless communication unit 126 transmits the shutter control signal generated by the shutter control unit 125 to the shutter glasses 200. The detailed configuration of the shutter control unit 125 will be described later.

The operation of the image display device 100 will be described. The television broadcast signal input to the antenna terminal 111 is supplied to the digital tuner 112. The digital tuner 112 processes the television broadcast signal and obtains predetermined bit stream data corresponding to the channel selected by the user.

The bit stream data output from the digital tuner 112 is supplied to the bit stream processing unit 113. In the bit stream processing unit 113, the image data or the audio data is extracted from the bit stream data. The image data extracted in the bit stream processing unit 113 is supplied to the 3D signal processing unit 114. The HDMI receiving unit 124 receives the image data and the audio data transmitted from the HDMI source device which is not shown in the HDMI terminal 123. The image data received by the HDMI receiving unit 124 is supplied to the 3D signal processing unit 114.

The 3D signal processing unit 114 performs the decoding process according to the transmission method on the three-dimensional image data received by the HDMI receiving unit 124 or obtained by the bit stream processing unit 113, and sequentially obtains the left eye image data and the right eye image data in the respective frames. The left eye image data and the right eye image data are supplied to the video signal control unit 116.

Based on the left eye image data and the right eye image data in respective frames output from the 3D signal processing unit 114, the video signal control unit 116 generates the image data for the three-dimensional image display. For instance, the video signal control unit 116 generates the image data to display images on the LCD panel 118 in the time-sharing manner with a sequence of the left eye image→the right eye image→the left eye image→the right eye image→ . . . . The image data is supplied to the LCD driving unit 117. Based on the image data from the video signal control unit 116, the LCD driving unit 117 drives the LCD panel 118. In this manner, in the LCD panel 118, the left eye image and the right eye image having parallax are displayed in the time-sharing manner with a predetermined period.

From the video signal control unit 116, a predetermined signal generated based on the signal process is supplied to the shutter control unit 125. According to the signal, the shutter control unit 125 generates the shutter control signal controlling the shutter operation of the shutter glasses 200. The shutter control signal is transmitted to the shutter glasses 200 through the wireless communication unit 126.

### [Configuration of Shutter Glasses]

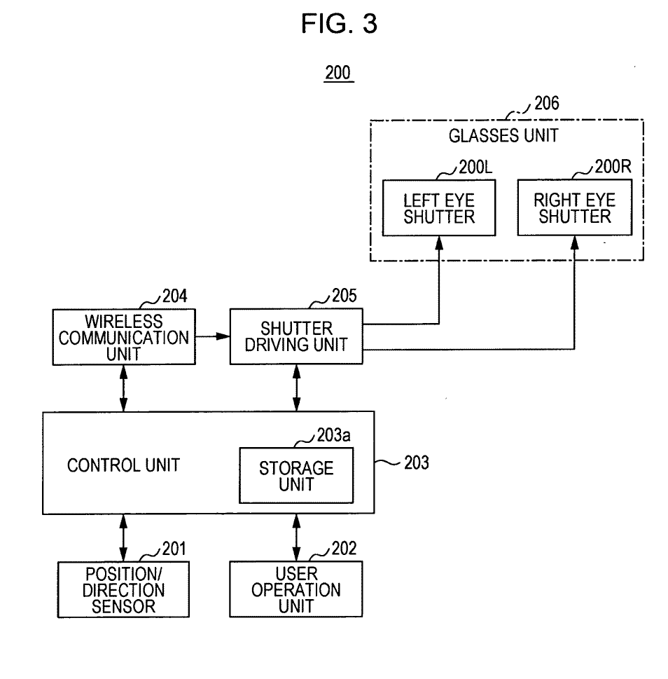

The shutter glasses 200 will be described. FIG. 3 shows a configuration example of the shutter glasses 200. The shutter glasses 200 include the position/direction sensor 201, a user operation unit 202, a control unit 203, a wireless communication unit 204, a shutter driving unit 205, and a glasses unit 206. As described above, the position/direction sensor 201 detects the position and the direction of the shutter glasses unit 206, that is, the shutter glasses 200, and obtains the positional information and the directional information, as the glasses state information. The position/direction sensor 201 constitutes the glasses state obtaining unit. The user operation unit 202 is used for the user to perform various operations, and constitutes the user interface. The user operation unit 202 contains a registration button for the user to perform the registration operation.

The control unit 203 controls the operation of the respective units in the shutter glasses 200. The position/direction sensor 201 and the user operation unit 202 are connected to the control unit 203. The control unit 203 includes a storage unit 203a. When the user performs the registration operation by pressing the registration button, the storage unit 203a holds the combination of the positional information and the directional information and the network address information of the image display device. Based on the information stored in the storage unit 203a and the information obtained by the position/direction sensor 201, the control unit 203 controls the wireless communication unit 204 to obtain the shutter control signal from a predetermined image display device. The control process by which the storage unit 203a holds information and the wireless communication unit 204 obtains the shutter control signal, which is performed by the control unit 203, will be described later.

The wireless communication unit 204 performs the wireless communication with the image display device 100 (100A and 100B), based on the IEEE802.15.4 for example. The wireless communication unit 204 receives the shutter control signal transmitted from the image display device 100. Based on the shutter control signal received by the wireless communication unit 204, the shutter driving unit 205 opens or closes the left eye shutter 200L and the right eye shutter 200R of the glasses unit 206. That is, the shutter driving unit 205 opens the left eye shutter 200L at the timing when the left eye image is displayed on the image display device 100. Also, the shutter driving unit 205 opens the right eye shutter 200R at the timing when the right eye image is displayed on the image display device 100. The detailed configuration of the shutter driving unit 205 will be described later.

### [Operation of Shutter Glasses]

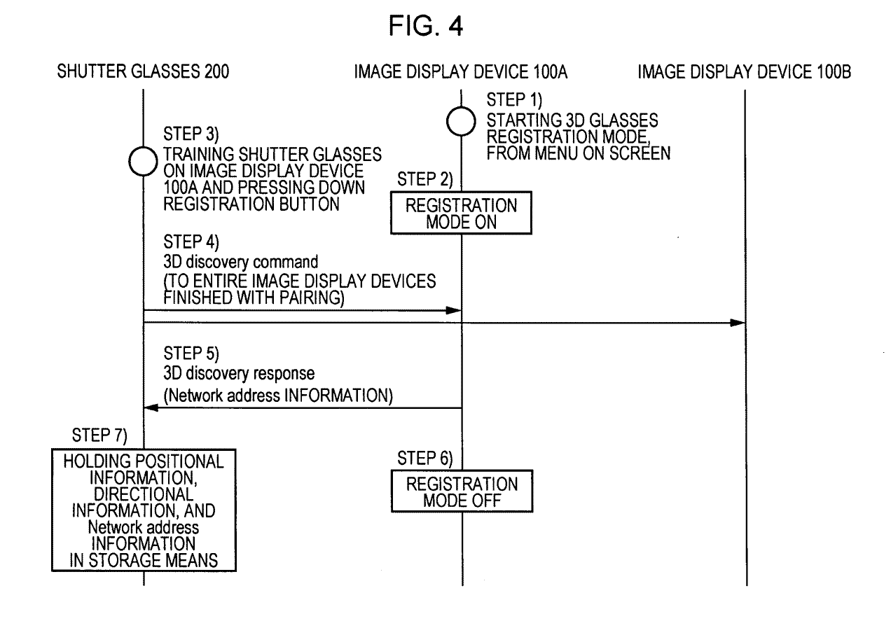

The operation of the shutter glasses 200 will be described. First, the operation performed to hold the information into the storage unit 203a will be described. This operation is performed under the control of the control unit 203. FIG. 4 shows an example of a registration sequence. The registration sequence example is the example in a case where the network address information of the image display device 100A is combined with the positional information and the directional information obtained by the position/direction sensor 201, and then is held into the storage unit 203a.

In step 1, the user performs the operation to start the 3D glasses registration mode, from the menu on the screen of the image display device 100A. In step 2, the registration mode is “ON” in the image display device 100A. Next, in step 3, in the observation position, the user trains the shutter glasses 200 on the image display device 100A, and presses down the registration button in the user operation unit 202. When the registration button is pressed down, in step 4, the shutter glasses 200 transmit the discovery command (3D discovery command) to all image display devices finished with pairing, through the wireless communication unit 204. Herein, all the image display devices finished with pairing are the image display device 100A and the image display device 100B, so the discovery command is transmitted to these.

Since the registration mode is “ON” in the image display device 100A, in step 5, the image display device 100A returns the discovery response (3D discovery response) to the shutter glasses 200, in response to the transmission of the discovery command. The discovery response contains the network address information of the image display device 100A. Since the registration mode is not “ON” in the image display device 100B, the discovery response is not returned. In step 6, after the discovery response is returned, the registration mode becomes “OFF” in the image display device 100A. In step 7, the shutter glasses 200 combines the network address information of the image display device 100A with the positional information and the directional information obtained by the position/direction sensor 201, and holds the combination into the storage unit 203a.

When the network address information of the image display device 100B is combined with the positional information and the directional information obtained by the position/direction sensor 201 and held in the storage unit 203a, the same registration sequence example is applied, even though the description thereof is omitted.

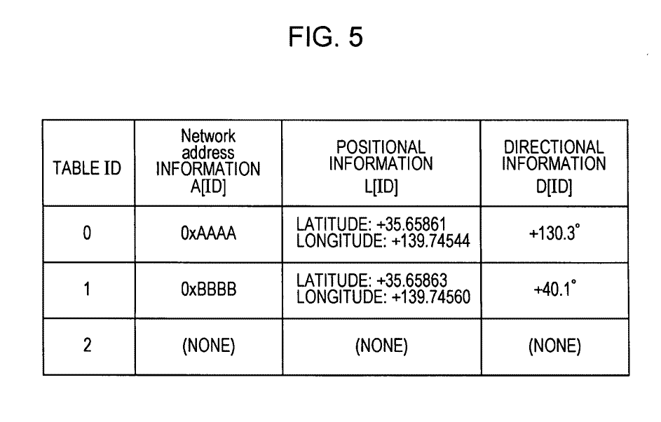

FIG. 5 shows an example of information management of the storage unit 203a. In the information management example, two combinations are held. For instance, the combination represented by Table ID=0 has the network address information A[ID] of “0xAAAA”, the positional information L[ID] of “latitude:+3565861” and “longitude:+139.74544”, and the directional information D[ID] of “+130.3°”. For example, the combination represented by Table ID=1 has the network address information A[ID] of “0xBBBB”, the positional information L[ID] of “latitude:+3565863” and “longitude:+139.74560”, and the directional information D[ID] of “+40.1°”.

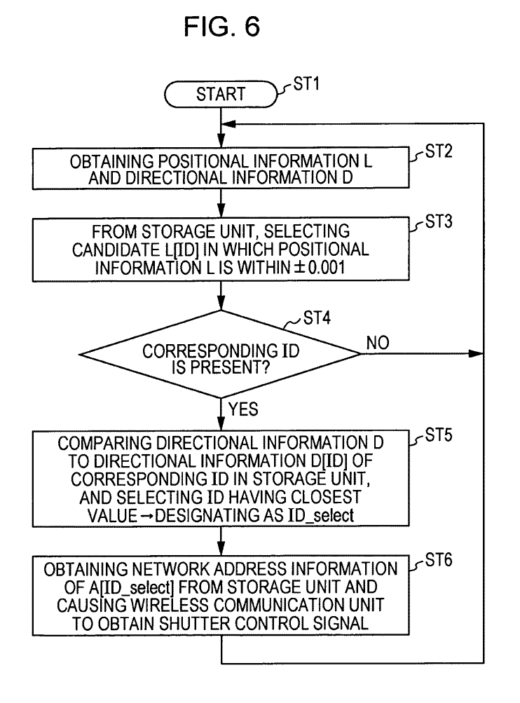

Next, the operation for obtaining the shutter control signal will be described. The operation is performed under the control of the control unit 203. The flowchart in FIG. 6 shows an example of the sequence of control process of the control unit 203. In step ST1, the control unit 203 starts the control process. For example, when the power becomes “ON” in the shutter glasses 200, the control process is started.

In step ST2, the control unit 203 obtains the positional information L and the directional information D from the position/direction sensor 201. In step ST3, the control unit 203 selects a candidate L[ID] in which the positional information L is within ±0.001 by the storage unit 203a. Thereafter, in step ST4, the control unit 203 determines whether there is a corresponding ID (combination). When there is no corresponding ID, the control unit 203 returns to the process in the step ST2.

When there is a corresponding ID in step ST4, the control unit 203 compares the directional information D to the directional information of the corresponding ID in the storage unit 203a, selects the ID having a close value, and designates it as ID_select, in step ST5. In step ST6, the control unit 203 obtains the network address information of A[ID_select] from the storage unit 203a. Moreover, in the step ST6, the control unit 203 controls the wireless communication unit 204 to obtain the shutter control signal from the corresponding image display device by the network address information of A[ID_select]. After the process in step ST6, the control unit 203 returns to the process in step ST2.

In the control process in the flowchart of FIG. 6, it is thought that there is a case where the user wears the shutter glasses 200 and turns their gaze to the image display device 100A in the observation position. In this case, the network address information of the image display device 100A is obtained as A[ID_select]. Accordingly, the wireless communication unit 204 performs the wireless communication with the image display device 100A, and obtains the shutter control signal from the image display device 100A.

In the control process in the flowchart of FIG. 6, it is thought that there is a case where the user wears the shutter glasses 200 and turns their gaze to the image display device 100B in the observation position. In this case, the network address information of the image display device 100A is obtained as A[ID_select]. Accordingly, the wireless communication unit 204 performs the wireless communication with the image display device 100B, and obtains the shutter control signal from the image display device 100A.

In the shutter glasses 200 shown in FIG. 3, the shutter control signal obtained by the wireless communication unit 204 is supplied to the shutter driving unit 205. Based on the shutter control signal, the shutter driving unit 205 drives the left eye shutter 200L and the right eye shutter 200R constituting the glasses unit 206.

When the user wearing the shutter glasses 200 turns their gaze to the image display device 100A in the observation position, the wireless communication unit 204 obtains the shutter control signal transmitted from the image display device 100A, as described above. Therefore, the left eye shutter 200L and the right eye shutter 200R of the glasses unit 206 are opened and closed according to the display of the left eye image and the right eye image of the image display device 100A. That is, the left eye shutter 200L is opened at the timing when the left eye image is displayed on the image display device 100A, and the right eye shutter 200R is opened at the timing when the right eye image is displayed on the image display device 100A. Accordingly, the user can perceive only the left eye image with the left eye, and only the right eye image with the right eye, and also, based on the left eye image and the right eye image having parallax and displayed on the image display device 100A, the user can perceive the three-dimensional image.

When the user wearing the shutter glasses 200 turns their gaze to the image display device 100B in the observation position, the wireless communication unit 204 obtains the shutter control signal transmitted from the image display device 100B, as described above. Therefore, the left eye shutter 200L and the right eye shutter 200R of the glasses unit 206 are opened and closed according to the display of the left eye image and the right eye image of the image display device 100B. That is, the Left eye shutter 200L is opened at the timing when the left eye image is displayed on the image display device 100B, and the right eye shutter 200R is opened at the timing when the right eye image is displayed on the image display device 100B. Accordingly, the user can perceive only the left eye image with the left eye, and only the right eye image with the right eye, and also, based on the left eye image and the right eye image having parallax and displayed on the image display device 100B, the user can perceive the three-dimensional image.

### [Detailed Configuration Example of Transmission/Reception System of Shutter Control Signal]

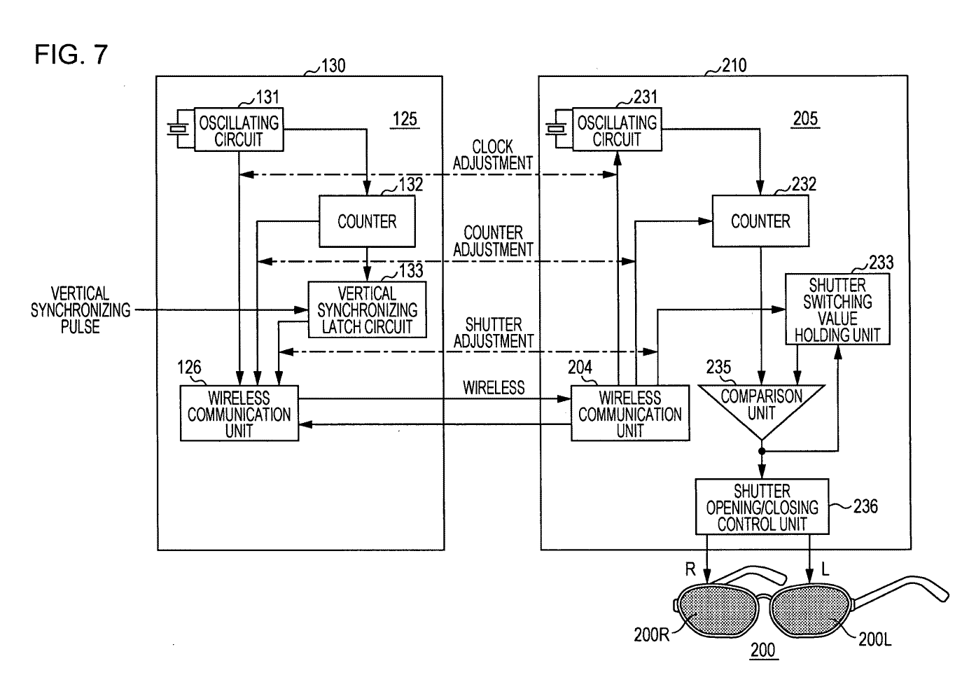

Herein, the detailed configuration of the transmission system of the shutter control signal of the image display device 100 and the reception system of the shutter control signal of the image display device 100 will be described. FIG. 7 shows a configuration example of a transmission system 130 of the shutter control signal of the image display device 100 and a reception system 210 of the shutter control signal of the shutter glasses 200. The transmission system 130 includes the wireless communication unit 126, an oscillating circuit 131, a counter 132, and a vertical synchronizing latch circuit 133. The oscillating circuit 131, the counter 132, and the vertical synchronizing latch circuit 133 constitute the shutter control unit 125 (refer to FIG. 2). The reception system 210 includes the wireless communication unit 204, an oscillating circuit 231, a counter 232, a shutter switching value holding unit 233, a comparison unit 235, and a shutter opening/closing control unit 236. The oscillating circuit 231, the counter 232, the shutter switching value holding unit 233, the comparison unit 235, and the shutter opening/closing control unit 236 constitute the shutter driving unit (refer to FIG. 3)

The oscillating circuit 131 is a circuit that includes a quarts oscillator and oscillates in a predetermined frequency. The clock generated by the oscillating circuit 131 is supplied to the counter 132. Based on the clock generated by the oscillating circuit 131, the counter 132 increases values. The counter 132 is used for instructing the opening/closing timing of the left eye shutter 200L and the right eye shutter 200R of the shutter glasses 200. The value of the counter 132 is controlled between the image display device 100 and the shutter glasses 200 so that the value becomes identical to the value of the counter 232.

The vertical synchronizing latch circuit 133 is a circuit holding the value of the counter 132 at the timing when the supply of a vertical synchronizing pulse is received from the outside of the transmission system 130. The value of the counter 132 held in the vertical synchronizing latch circuit 133 is wirelessly transmitted to the shutter glasses 200 from the wireless communication unit 126, and stored in the reception system 210. The wireless communication unit 126 performs the wireless communication with a wireless communication unit 234 of the reception system 210, based on the IEEE802.15.4.

The reception system 210 transmits the request for the synchronization of the clock frequency to the image display device 100, receives a packet wirelessly transmitted from the image display device 100 to synchronize the clock frequency, or controls the opening/closing timing of the left eye shutter 200L and the right eye shutter 200R. The oscillating circuit 231 includes a quartz oscillator and oscillates in a predetermined frequency. The clock generated by the oscillating circuit 231 is supplied to the counter 232.

The counter 232 is a counter that increases values thereof based on the clock generated by the oscillating circuit 231. The counter 232 is a counter used for switching the opening and closing of the left eye shutter 200L and the right eye shutter 200R of the shutter glasses 200. The comparison unit 235 compares the value of the counter 232 to the value held in the shutter switching value holding unit 233, and when the values are identical, the shutter opening/closing control unit 236 controls such that the left eye shutter 200L and the right eye shutter 200R are opened or closed. The bit length of the counter 232 is the same as that of the counter 132.

The shutter switching value holding unit 233 holds the information of the counter value, which is wirelessly transmitted from the image display device 100 through the wireless communication unit 126 and instructs the shutter opening/closing timing. When the value of the counter 232 increasing by the clock generated by the oscillating circuit 231 is identical to the value stored in the shutter switching value holding unit 233, the shutter opening/closing control unit 236 controls such that the left eye shutter 200L and the right eye shutter 200R are opened or closed. The wireless communication unit 204 performs the wireless communication with the RF communication unit 126 of the transmission system 130, based on the IEEE802.15.4.

The comparison unit 235 compares the value of the counter 232 increasing by the clock generated by the oscillating circuit 231 to the value stored in the shutter switching value holding unit 233. When the values are identical, the comparison unit 235 transmits the opening/closing instruction to the shutter opening/closing control unit 236, so that the left eye shutter 200L and the right eye shutter 200R are opened or closed. Also, the comparison unit 235 instructs the shutter switching value holding unit 233 such that the value stored in the shutter switching value holding unit 233 increases to meet the subsequent opening/closing timing. The value to increase is transmitted beforehand to the shutter glasses 200 from the image display device 100, as a switching frequency.

The shutter opening/closing control unit 236 opens or closes the left eye shutter 200L and the right eye shutter 200R, and opens or closes a right eye image transmitting portion 212 and a left eye image transmitting portion 214, based on the opening/closing instruction from the comparison unit 235.

In this configuration of the transmission system 130 and the reception system 210, it is not necessary to wirelessly transmit the opening/closing instruction of the left eye shutter 200L and the right eye shutter 200R at very short intervals, from the image display device 100 to the shutter glasses 200. Through the comparison of the value of a self-propelled counter 232 in the shutter glasses 200 to the value held in the shutter switching value holding unit 233, the shutter glasses 200 can open or close the left eye shutter 200L and the right eye shutter 200R.

The configuration of the transmission system 130 of the image display device 100 and the reception system 210 of the shutter glasses 200 has been described so far, by using the FIG. 7. In order to open or close the left eye shutter 200L and the right eye shutter 200R of the shutter glasses 200 based on the counter value transmitted from the image display device 100 in this way, it is necessary for the clock frequency of the transmission system 130 and the reception system 210 to be identical. Therefore, before performing the opening/closing operation of the left eye shutter 200L and the right eye shutter 200R, the shutter glasses 200 perform a process of completely matching the clock frequency of the transmission system 130 and the reception system 210.

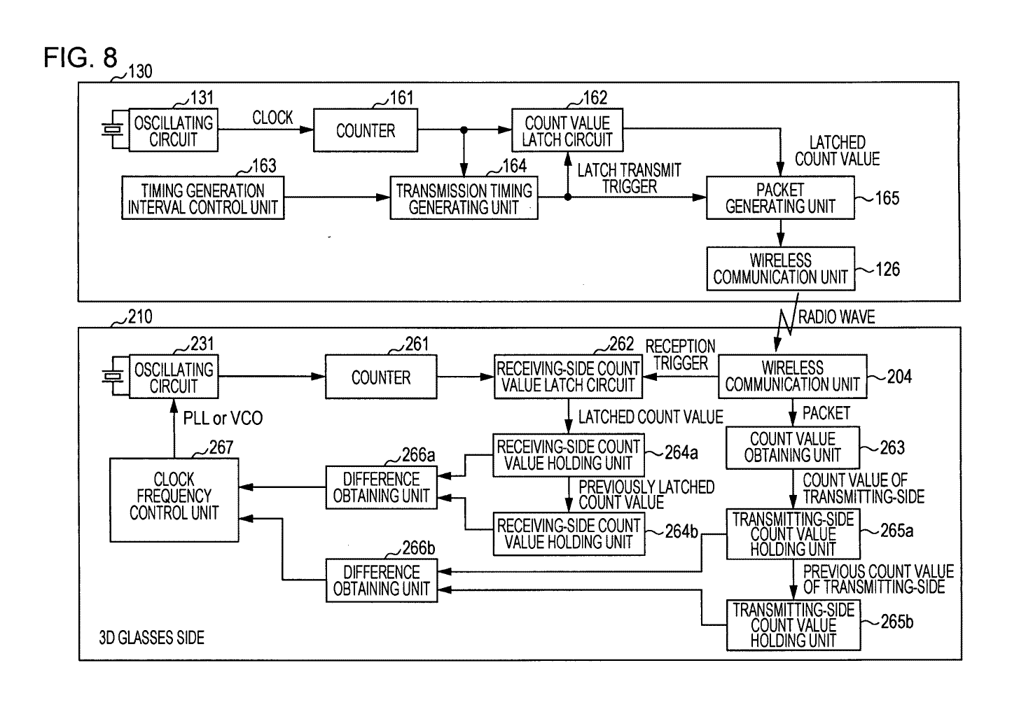

The configuration for performing the process of matching the clock frequency of the transmission system 130 and the reception system 210 will now be described. FIG. 8 is a diagram illustrating the configuration of the transmission system 130 and the reception system 210, and shows the configuration for performing the process of matching the clock frequency of the transmission system 130 and the reception system 210.

The transmission system 130 includes the oscillating circuit 131 including a quartz oscillator, the wireless communication unit 126, a counter 161, a count value latch circuit 162, a timing generation interval control unit 163, a transmission timing generating unit 164, and a packet generating unit 165. The reception system 210 includes the oscillating circuit 231, the wireless communication unit 204, a counter 261, a receiving-side count value latch circuit 262, and a count value obtaining unit 263. The reception system 210 also includes receiving-side count value holding units 264a and 264b, transmitting-side count value holding units 265a and 265b, a difference obtaining unit 266a and 266b, and a clock frequency control unit 267.

The counter 161 is a counter for matching the clock frequency of the transmission system 130 and the reception system 210, and for increasing values based on the clock generated by the oscillating circuit 131. The count value latch circuit 162 latches the value of the counter 161, and the latched timing is a timing when the latch transmit trigger from the transmission timing generating unit 164 is received.

The timing generation interval control unit 163 is a unit controlling the interval of the packet transmit timing from the RF communication unit 134. The timing generation interval control unit 163 notifies the transmission timing generating unit 164 of the transmission timing of the packet, at intervals of several hundreds of milliseconds for example. In response to the request of the shutter glasses 200 for the synchronization of the clock frequency, the timing generation interval control unit 163 starts to provide notification to the transmission timing generating unit 164.

The transmission timing generating unit 164 notifies the packet generating unit 165 of the transmission timing of the packet. The transmission timing generating unit 164 receiving the notification from the timing generation interval control unit 163 transmits the latch transmit trigger to the count value latch circuit 162. The transmission timing generating unit 164 also instructs the packet generating unit 165 to generate a packet containing the information of the count value latched by the count value latch circuit 162.

The packet generating unit 165 generates the packet containing the information of the count value latched by the count value latch circuit 162. The packet generated by the packet generating unit 165 is wirelessly transmitted from the RF communication unit 134.

The counter 261 is a counter for matching the clock frequency of the transmission system 130 and the reception system 210, and for increasing values based on the clock generated by the oscillating circuit 231. The receiving-side count value latch circuit 262 is a circuit for latching the value of the counter 261 and for latching the value of the counter 261 at the timing when the RF communication unit 234 receives the packet containing the information of the count value latched by the count value latch circuit 162. The value of the counter 261 latched by the receiving-side count value latch circuit 262 is transmitted to the receiving-side count value holding unit 264a. At the timing when the value of the counter 261 latched by the receiving-side count value latch circuit 262 is transmitted to the receiving-side count value holding unit 264a, the value which has been held in the receiving-side count value holding unit 264a is transmitted to the receiving-side count value holding unit 264b.

The count value obtaining unit 263 obtains the information of the count value which is latched by the count value latch circuit 162 and contained in the packet received by the RF communication unit 234. The information of the count value obtained by the count value obtaining unit 263 is transmitted to the transmitting-side count value holding unit 265a.

The receiving-side count value holding units 264a and 264b hold the value of the counter 261 latched by the receiving-side count value latch circuit 262. The receiving-side count value holding unit 264a holds the value of the counter 261 latched by the receiving-side count value latch circuit 262, at the timing when the packet which is transmitted from the RF communication unit 134 and contains the information of the count value latched by the count value latch circuit 162 is received. The receiving-side count value holding unit 264b holds the value of the counter 261 latched by the receiving-side count value latch circuit 262, at the timing when the packet which is transmitted from the RF communication unit 134 and contains the information of the count value latched by the count value latch circuit 162 is received.

The transmitting-side count value holding units 265a and 265b hold the count value which is obtained by the count value obtaining unit 263 and latched by the count value latch circuit 162. The transmitting-side count value holding unit 265a holds the count value at the timing when the packet which is transmitted from the RF communication unit 134 and contains the information of the count value latched by the count value latch circuit 162 is received. The transmitting-side count value holding unit 265b also holds the count value at the timing when the packet which is transmitted from the RF communication unit 134 and contains the information of the count value latched by the count value latch circuit 162 is received.

The difference obtaining unit 266a obtains the difference in the value held in the receiving-side count value holding units 264a and 264b. Similarly, the difference obtaining unit 266b obtains the difference in the value held in the transmitting-side count value holding units 265a and 265b. Comparing the differences obtained by the difference obtaining units 266a and 266b by using the clock frequency control unit 267 makes it possible to grasp the difference in the clock frequency between the oscillating circuit 131 and the oscillating circuit 231 by the clock frequency control unit 267.

The clock frequency control unit 267 compares the difference obtained by the difference obtaining units 266a and 266b, grasps the difference in the clock frequency between the transmitting-side and the receiving-side, and controls the clock frequency of the oscillating circuit 231. That is, when the difference of the transmitting-side counter 161 is larger than that of the receiving-side counter 261, the clock frequency of the clock generated by the oscillating circuit 131 is higher than the clock frequency of the clock generated by the oscillating circuit 231. Therefore, the clock frequency control unit 267 controls the clock frequency of the oscillating circuit 231 to be high so that the frequency is tuned to the clock frequency of the oscillating circuit 131.

In this manner, by configuring the transmission system 130 and the reception system 210, it is possible to tune the clock frequency of the oscillating circuit 131 to the clock frequency of the oscillating circuit 231. The shutter control unit 125 may continuously perform the control process of the clock frequency of the oscillating circuit 231 performed by the clock frequency control unit 267 a plurality of times.

The configuration for performing the process of matching the clock frequency of the transmission system 130 and the reception system 210 has been described so far by using FIG. 8. Now, the operation of the image display observation system 10 will be described.

### [A Series of Operation of Image Display Device and Shutter Glasses]

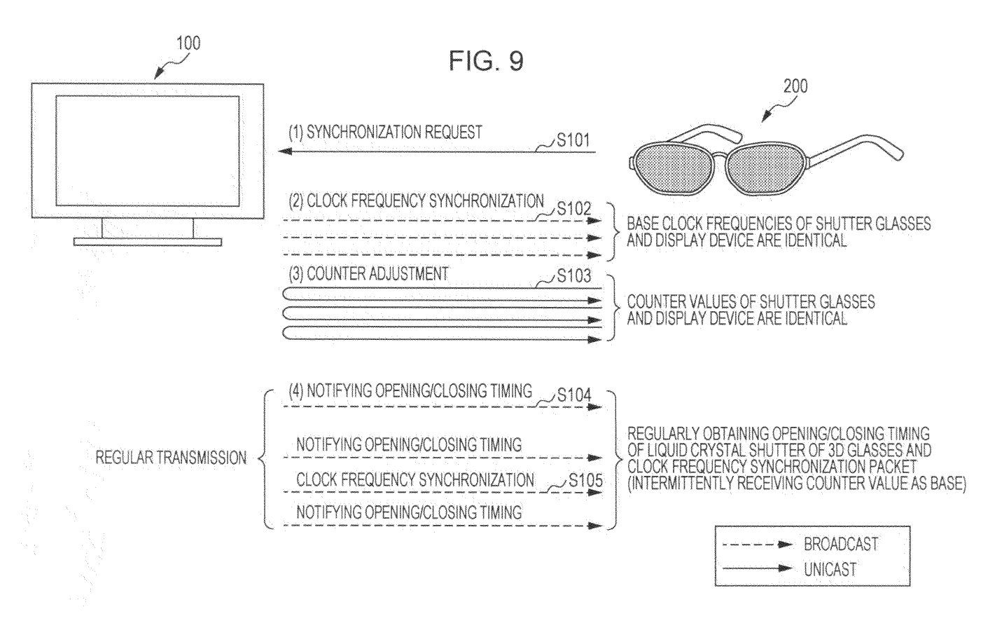

FIG. 9 shows a series of operations performed between the image display device 100 (100A and 100B) and the shutter glasses 200 included in the image display observation system 10. In FIG. 9, regarding the line between the image display device 100 and the shutter glasses 200, a solid line represents the unicast transmission, and a broken line represents the broadcast transmission.

To see the image through the shutter glasses 200, the image displayed on the image display device 100 in the time-sharing manner, first, it is necessary to tune the clock frequency of the transmission system 130 and the reception system 210. Hence, the shutter glasses 200 wirelessly transmit the synchronization request of the clock frequency to the image display device 100 (step S101). The synchronization request packet of the clock frequency is generated in the reception system 210 for example.

The image display device 100 wirelessly receiving the synchronization request of the clock frequency from the shutter glasses 200 wirelessly transmits the packet containing the value of the counter 161 for synchronization of the clock frequency to the shutter glasses 200 (step S102). The image display device 100 also transmits by broadcast the packet containing the value of counter 161. The broadcast transmission of the packet will be described later.

After the synchronization of clock frequency is achieved, the shutter glasses 200 wirelessly transmit the matching request of the counter value of the counter 161 for instructing the opening/closing timing of the left eye shutter 200L and the right eye shutter 200R, to the image display device 100 (step S103). It is preferable that the matching process of the count values between the image display device 100 and the shutter glasses 200 are repeated multiple times until the counter values become completely identical, under the consideration of the time taken for the wireless communication and time variation. Here, the matching process of the counter value may be completed at a point in time when the degree of matching is within a certain allowable range.

After the count values are matched, the image display device 100 transmits wirelessly and by broadcast the value of the counter 132 at the timing when the image displayed on the image display device 100 in the time-sharing manner is switched to the shutter glasses 200 regularly (step S104). The value of the counter 132 transmitted in this manner becomes the opening/closing timing of the left eye shutter 200L and the right eye shutter 200R. The notification of the opening/closing timing is transmitted at intervals sufficiently longer (for example, at intervals of several hundreds of milliseconds) than the interval at which the image display device 100 switches images.

The difference in the clock frequency between the image display device 100 and the shutter glasses 200 are also corrected. In order to perform the correction, the image display device 100 wirelessly and regularly transmits the packet containing the counter value of the counter 161 for synchronization of the clock frequency to the shutter glasses 200 (step S105). Of course it is also considered that the transmission of the packet containing the counter value of the counter 161 is performed irregularly. For instance, the packet may be transmitted by broadcast from the image display device 100 at the switching timing of the image source, for example, at the timing when the contents change or at the timing when the channel of the image display device 100 is switched.

Due to the transmission of the opening/closing timing in step S104, it is possible to match the opening/closing timing of the left eye shutter 200L and the right eye shutter 200R of the shutter glasses 200 with the switching timing of the image displayed on the image display device 100. In some cases, the switching timing of the image displayed on the image display device 100 varies with factors such as switching of the image source. Therefore, it is preferable for the image display device 100 to transmit the opening/closing timing of the left eye shutter 200L and the right eye shutter 200R in a predetermined period as described above.

According to the transmission of the opening/closing timing in step S104, various parameters regarding the opening/closing timing are also wirelessly transmitted from the image display device 100. When the image display device 100 displays images, the vertical synchronizing pulse is not constant but changed depending on the areas and the structure of devices. The opening/closing timing of the shutter glasses 200 are also changed depending on the type of display panel. Accordingly, by transmitting various parameters regarding the opening/closing timing from the image display device 100 to the shutter glasses 200, it is possible for the shutter glasses 200 to correspond to various types of image display devices.

In order to make the image displayed on the LCD panel 118 (refer to FIG. 2) to be perceived as a three-dimensional image, the opening/closing pattern of the shutter (liquid crystal shutter) of the shutter glasses 200 works such that the left eye shutter 200L and the right eye shutter 200R are alternatively opened, so the shutters are not opened simultaneously. Also, to prevent crosstalk, it is preferable to set the time for which both the shutters are closed, in the time period from the closing of one shutter to the opening of the other shutter. However, if both the shutters are closed for too long, the time for which each shutter is opened is shortened; therefore, the amount of light reaching the user's eyes decreases, so the image looks dark.

The shutter opening/closing period of the shutter glasses 200 are determined depending on the frame period and the number of image replacements of the image display device 100. The frame period of the image display device 100 varies with the frame frequency of the image source or whether the image quality improving process such as a process of increasing the display frame number performed by the image display device 100 is performed. The time for which both the shutters are closed to prevent crosstalk is affected by the number of image replacements of the image display device 100. Also, the optimal value of time for which both the shutters are closed to prevent crosstalk varies with the type of device of the display panel (for example, CRT, liquid crystal, LED liquid crystal, plasma, and organic EL) and the scanning method of the display panel. In the image display device 100 shown in FIG. 2, the display panel is LCD panel 118.

Therefore, the optimal value of the shutter opening/closing timing of the shutter glasses 200 are determined not by the shutter glasses 200 but by the configuration and the image source of the image display device 100. The image source is perceived by the user not only as the three-dimensional image but also as the traditional two-dimensional image. When the two-dimensional image is displayed on the image display device 100, it is preferable to stop the shutter opening/closing operation of the shutter glasses 200 to see the image easily, and to keep the shutter opened all the time.

As described above, at what timing the shutter opening/closing operation of the shutter glasses 200 are performed is notified from the image display device 100 to the shutter glasses 200 as the parameter, whereby the shutter opening/closing timing of the shutter glasses 200 are easily optimized. Specifically, the image display device 100 transmits the shutter opening/closing period, the image transmission time of the shutter, and the offset time applied until the image transmission time of each of the left and right shutter starts to the shutter glasses 200 as the parameter. In this manner, the opening/closing timing of the liquid crystal shutter of the shutter glasses 200 are optimized.

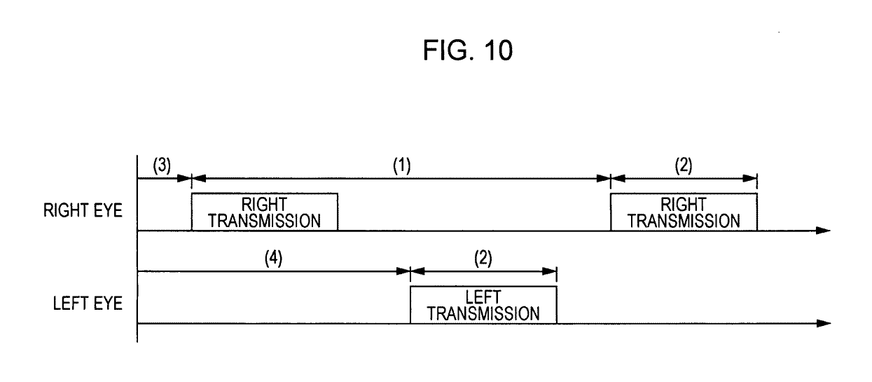

FIG. 10 shows an example of the opening/closing timing of the left eye shutter 200L and the right eye shutter 200R. (1) represents the shutter (liquid crystal shutter) opening/closing period, and the period is coincident with the switching period of the image displayed on the image display device 100. (2) represents the image transmission time of the shutter (time for which the shutter is opened) for which the light passes through the left eye shutter 200L and the right eye shutter 200R of the shutter glasses 200 for one period. In principle, the right eye and the left eye have the same image transmission time. The optimal image transmission time is determined depending on the type and the frame frequency of the image display device 100. (3) and (4) are the offset time from the starting point of the shutter opening/closing period to the opening of each of the right and left shutter.

The parameter of (1) to (4) transmitted from the image display device 100 is based on the value of the counter 132 (counter 232). When the image display device 100 transmits the parameter to the shutter glasses 200, the clock frequency of the image display device 100 and the shutter glasses 200 are in synchronization with the value of the counters 132 and 232. Accordingly, transmitting the relative value and the absolute value of the counter value as the parameter of (1) to (4) makes it possible to control the shutter opening/closing timing of the shutter glasses 200 from the image display device 100.

The image display device 100 also wirelessly transmits the timing when the information regarding the opening/closing timing is to be transmitted to the shutter glasses 200. In this way, it is possible for the shutter glasses 200 to keep down power consumption by switching the reception “ON/OFF” with the timing.

In the configuration, the synchronization of the clock frequency is achieved in advance between the image display device 100 and the shutter glasses 200, and the image display device 100 regularly notifies the opening/closing timing of the left eye shutter 200L and the right eye shutter 200R. With this configuration, the shutter glasses 200 operate the wireless communication unit 204 only at the timing when the opening/closing timing is notified. Therefore, compared to the case where the image display device 100 notifies the image switching timing and the opening/closing timing simultaneously, power consumption of the image display device 100 and the shutter glasses 200 can be drastically reduced.

Since the image display device 100 notifies the information of opening/closing timing in advance, the opening/closing operation of the left eye shutter 200L and the right eye shutter 200R can be continued based on the self-propelled counter 232 in the shutter glasses 200. Accordingly, even when the shutter glasses 200 fails to receive the packet from the image display device 100 for some reason, the opening/closing operation of the left eye shutter 200L and the right eye shutter 200R is performed favorably.

Now, the type of packet which is wirelessly transmitted and received between the image display device 100 and the shutter glasses 200 will be reviewed. The packet which is wirelessly transmitted and received between the image display device 100 and the shutter glasses 200 includes a (1) clock frequency synchronization request packet, a (2) clock frequency synchronization packet, a (3) counter adjustment packet, a (4) parameter notification packet, a (5) shutter timing notification packet, and a (6) shutter timing and parameter inquiry packet.

The (1) clock frequency synchronization request packet is transmitted from the shutter glasses 200 to the image display device 100. After receiving the clock frequency synchronization request packet, the image display device 100 returns the value of the counter 161 used for the synchronization of the clock frequency to the shutter glasses 200 over multiple times, by using the (2) clock frequency synchronization packet.

As described above, the (2) clock frequency synchronization packet is used when the image display device receiving the (1) clock frequency synchronization request packet transmits the value of the counter 161 used for the synchronization of the clock frequency to the shutter glasses 200 over multiple times.

The (3) counter adjustment packet is a two-way packet wirelessly transmitted and received between the image display device 100 and the shutter glasses 200, and is transmitted from the shutter glasses 200 having the clock frequency synchronized with the image display device 100. The value of the counter 132 is returned from the image display device 100 and used for counter adjustment in the shutter glasses 200.

The (4) parameter notification packet is used for transmitting various parameters regarding the shutter opening/closing timing of the shutter glasses 200 described above, from the image display device 100 to the shutter glasses 200. The (4) parameter notification packet may be transmitted at the same timing as the transmission of the (2) clock frequency synchronization packet.

The (5) shutter timing notification packet is transmitted regularly and by broadcast from the image display device 100 to the shutter glasses 200, and used for notifying the opening/closing timing of the shutter glasses 200 with the counter value.

When the shutter glasses 200 fail to receive the (5) shutter timing notification packet from the image display device 100, the (6) shutter timing and the parameter inquiry packet request for the transmission of the shutter timing notification packet separately. The response from the image display device 100 receiving the inquiry packet is transmitted in the unicast manner.

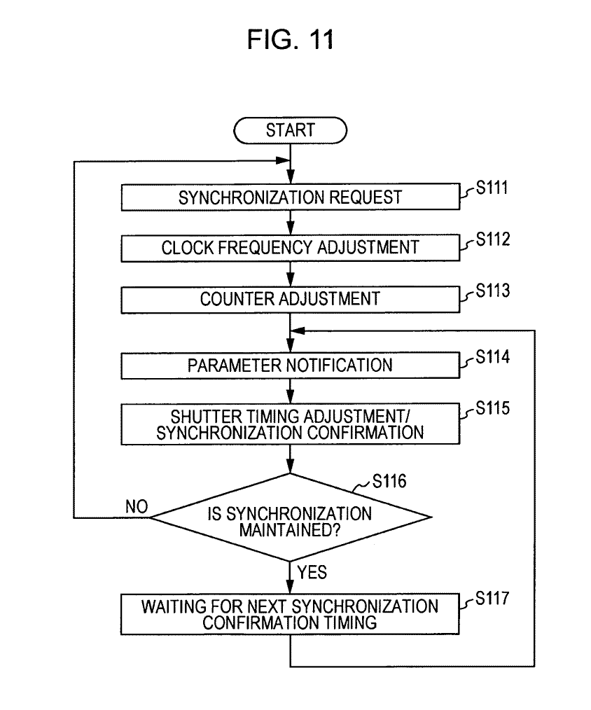

The flowchart in FIG. 11 shows a series of operations performed between the image display device 100 and the shutter glasses 200. First, the shutter glasses 200 wirelessly transmit the clock frequency synchronization request to the image display device 100 (step S111). The clock frequency synchronization request packet is generated in the reception system 210 for example. At the timing when the synchronization request is transmitted from the shutter glasses 200, the shutter control signal is obtained from the image display device 100 (timing in step ST6 in FIG. 6). After wirelessly receiving the clock frequency synchronization request from the shutter glasses 200, the image display device 100 wirelessly transmits the packet containing the counter value of the counter 161 used for synchronization of the clock frequency to the shutter glasses 200.

After receiving the packet containing the counter value of the counter 161 wirelessly transmitted from the image display device 100, the shutter glasses 200 perform a process of adjusting the clock frequency of the image display device 100 and the shutter glasses 200 (step S112). The process of adjusting the clock frequency of the image display device 100 and the shutter glasses 200 are performed by the configuration example shown in FIG. 7. However, the configuration in which the process of adjusting the clock frequency of the image display device 100 and the shutter glasses 200 are not limited to the configuration example shown in FIG. 7.

When the clock frequencies of the image display device 100 and the shutter glasses 200 are identical, the counter values used for the opening/closing of the left eye shutter 200L and the right eye shutter 200R are then made to be identical in the image display device 100 and the shutter glasses 200 (step S113). This process is performed in the following manner. That is, the shutter glasses 200 wirelessly transmit the matching request of the counter value used for instructing the opening/closing timing of the left eye shutter 200L and the right eye shutter 200R to the image display device 100. Meanwhile, in response to the matching request of the counter value, the image display device 100 wirelessly transmits the information of the counter value to the shutter glasses 200.

When the counter values of the image display device 100 and the shutter glasses 200 become identical, the image display device 100 notifies the shutter glasses 200 of the parameter including the switching period and the opening time of the left eye shutter 200L and the right eye shutter 200R (step S114). The image display device 100 also notifies the shutter glasses 200 of the opening/closing timing based on the counter value used for the opening/closing of the left eye shutter 200L and the right eye shutter 200R (step S115).

The parameter may be transmitted from the image display device 100 to the shutter glasses 200, at the point in time when the clock frequency of the image display device 100 and of the shutter glasses 200 become identical. When transmitting the opening/closing timing, the image display device 100 notifies the shutter glasses 200 of the current counter value, and the shutter glasses 200 compare the counter value of their own with the received counter value to check if there is desynchronization (step S116).

As a result of the determination performed in the step S116, when it is confirmed that the synchronization of the image display device 100 and the shutter glasses 200 are maintained, the shutter glasses 200 then wait for the next synchronization confirmation timing (step S117). On the other hand, as a result of the determination performed in the step S116, when it is confirmed that the image display device 100 and the shutter glasses 200 are out of synchronization, the procedure returns to the step S111, so the shutter glasses 200 wirelessly transmit the clock frequency synchronization request to the image display device 100.

When the clock frequency is completely identical between the transmitting-side (image display device 100) and the receiving-side (shutter glasses 200), it is not necessary for the image display device 100 to regularly and wirelessly transmit the opening/closing timing in a broadcast manner, as described above. This is because when the opening/closing timing is firstly transmitted from the image display device 100 to the shutter glasses 200, the respective clocks of the transmitting-side and the receiving-side proceed with counting, whereby the shutter opening/closing operation can be performed based on the counter value.

When the switching timing of the image displayed on the image display device 100 is changed due to the switching of channels or the contents to be played, it is necessary for the image display device 100 to notify the shutter glasses 200 of the change in the opening/closing timing. It is difficult for the shutter glasses 200 to predict the change in the opening/closing timing. However, if the shutter glasses 200 are put in a reception state all the time, power is consumed continuously for reception, and it is difficult to increase the battery operation time of the shutter glasses 200 which are battery-operated basically.

The shutter glasses 200 synchronize the clock frequency, make the counter values become identical, and then firstly receive the parameter regarding switching and the switching timing from the image display device 100. Thereafter, the shutter glasses 200 perform the reception operation intermittently. Therefore, it is possible to reduce the power consumed in the reception of the shutter glasses 200 drastically, and to increase the battery operation time of the shutter glasses 200.

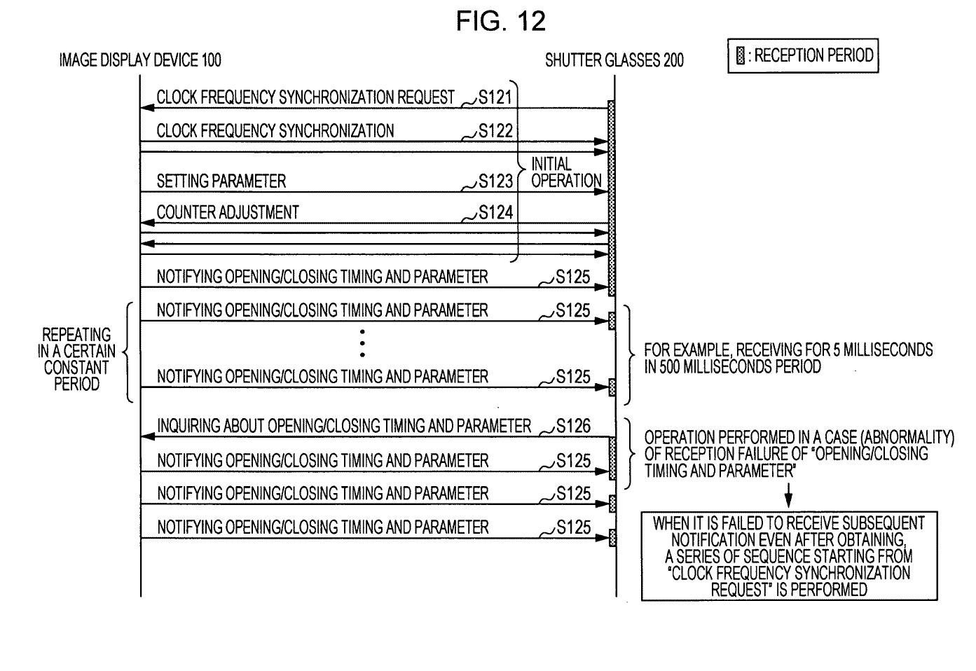

The sequence diagram in FIG. 12 shows a series of operations performed between the image display device 100 and the shutter glasses 200. In addition to a series of operations performed between the image display device 100 and the shutter glasses 200, FIG. 12 also illustrates the reception operation period of the wireless communication unit 204 in the shutter glasses 200. A series of operations performed between the image display device 100 and the shutter glasses 200 will be described hereinbelow by using FIG. 12.

First, the shutter glasses 200 wirelessly transmit the clock frequency synchronization request to the image display device 100 (step S121). The clock frequency synchronization request packet is generated in the reception system 210 for example. At the timing when the synchronization request is transmitted from the shutter glasses 200, the shutter control signal is obtained from the image display device 100 (timing of step ST6 in FIG. 6). After wirelessly receiving the clock frequency synchronization request from the shutter glasses 200, the image display device 100 wirelessly transmits the packet containing the counter value used for synchronization of the clock frequency to the shutter glasses 200. After receiving the packet, the shutter glasses 200 perform a process of adjusting the clock frequency of the image display device 100 and the shutter glasses 200 (step S122).

When the synchronization of clock frequency of the image display device 100 and the shutter glasses 200 are completed, the counter values used for the opening/closing of left eye shutter 200L and the right eye shutter 200R are then made to be identical between the image display device 100 and the shutter glasses 200 (step S124). Before this process of making the counter values identical, various parameters regarding the opening/closing of the left eye shutter 200L and the right eye shutter 200R may be transmitted from the image display device 100 to the shutter glasses 200 (step S123).

When the counter values become identical between the image display device 100 and the shutter glasses 200, the image display device 100 notifies the shutter glasses 200 of the parameter including the switching period and the opening time of the left eye shutter 200L and the right eye shutter 200R. The image display device 100 also notifies the shutter glasses 200 of the opening/closing timing based on the counter value used for the opening/closing of left eye shutter 200L and the right eye shutter 200R (step S125). After the initial notification, the image display device 100 wirelessly transmits the parameter and the information of the opening/closing timing at intervals set in advance.

In the shutter glasses 200, the time period from the wireless transmission of the clock frequency synchronization request in the step S121 to the initial notification from the image display device 100 is the reception operation period of the wireless communication unit 204. Thereafter, according to the notification of the information on the parameter and the opening/closing timing transmitted from the image display device 100, the wireless communication unit 204 performs the reception operation for a predetermined time and then is put in the halt state when it does not perform the reception operation. For example, when the information on the parameter and the opening/closing timing is wirelessly transmitted from the image display device 100 at the interval of 500 milliseconds, the shutter glasses 200 make the wireless communication unit 204 perform the reception operation only for 5 milliseconds at the timing of the wireless transmission from the image display device 100.

The wireless communication herein is performed based on the IEEE802.15.4. for example. In the IEEE802.15.4., it takes about several milliseconds from the halt state to the transmission or from the reception to the halt state, hence the wireless communication can be performed within this time. Accordingly, it is possible for the shutter glasses 200 to drastically reduce the power consumption in wireless communication to about one hundredth compared to the constant reception state. The standard of the wireless communication system between the image display device 100 and the shutter glasses 200 are not limited to this example. However, as described above, it is preferable to use a standard in which it takes about several milliseconds or shorter from the halt state to the transmission or from the reception to the halt state.

In order to realize the intermittent reception operation of the shutter glasses 200 as above, it is of course necessary for the image display device 100 to wirelessly transmit the information on the parameter and the opening/closing timing in the reception operation period of the shutter glasses 200, and this can be realized by achieving clock frequency synchronization in advance between the image display device 100 and the shutter glasses 200.

When normal reception of the information on the parameter and the opening/closing timing fails due to factors such as the presence of obstructions and desynchronization, the shutter glasses 200 inquire of the image display device 100 about the information on the parameter and the opening/closing timing (step S126). The inquiry may be sent from the shutter glasses 200 to the image display device 100 immediately once the normal reception is failed; alternatively, the inquiry may be sent from the shutter glasses 200 to the image display device 100 when the normal reception is repeatedly failed several times. After receiving the inquiry from the shutter glasses 200, the image display device 100 wirelessly transmits the information on the parameter and the opening/closing timing to the shutter glasses 200.

When the reception of the information on the parameter and the opening/closing timing from the image display device 100 fails even after sending the inquiry to the image display device 100, the shutter glasses 200 determine that there is desynchronization. The shutter glasses 200 then wirelessly transmit the clock frequency synchronization request to the image display device 100 again, and perform a series of processes from the beginning. In some cases, there is no response from the image display device 100 even when the shutter glasses 200 wirelessly transmit the clock frequency synchronization request to the image display device 100 again. In this case, it is possible for the shutter glasses 200 to determine that power supply is cut in the image display device 100 and to enter into the halt state where the power is not consumed by itself.

In the image display observation system 10 shown in FIG. 1 as above, the image display device from which the shutter control signal is supposed to be obtained is specified based on the glasses state (positional and directional state) of the shutter glasses 200 (the shutter glasses unit 206). Therefore, it is not necessary for the user to select and switch the image display device themselves, whereby the usability is improved.

For instance, when the user faces the direction of the image display device 100A in the observation position, the image display device 100A specified as the image display device from which the shutter control signal is supposed to be obtained. That is, the network address information of the image display device 100A is obtained by the storage unit 203a, and the shutter glasses 200 are automatically put in the state of wireless communication for exchanging shutter control signals with the image display device 100A.

Accordingly, when the user faces the direction of the image display device 100A in the observation position, the left eye shutter 200L is opened at the timing when the left eye image is displayed on the image display device 100A, and the right eye shutter 200R is opened at the timing when the right eye image is displayed on the image display device 100A. Hence, the user can perceive the three-dimensional image based on the left eye image and the right eye image having parallax and displayed on the image display device 100A.

As another example, when the user faces the direction of image display device 100B, the image display device 100B specified as the image display device from which the shutter control signal is supposed to be obtained. That is, the network address information of the image display device 100B is obtained by the storage unit 203a, and the shutter glasses 200 are automatically put in the state of wireless communication for exchanging shutter control signal with the image display device 100B.

Accordingly, when the user faces the direction of the image display device 100B in the observation position, the left eye shutter 200L is opened at the timing when the left eye image is displayed on the image display device 100B, and the right eye shutter 200R is opened at the timing when the right eye image is displayed on the image display device 100B. Hence, the user can perceive the three-dimensional image based on the left eye image and the right eye image having parallax and displayed on the image display device 100B.

### 2. A Second Embodiment

### [Configuration Example of Image Display Observation System]

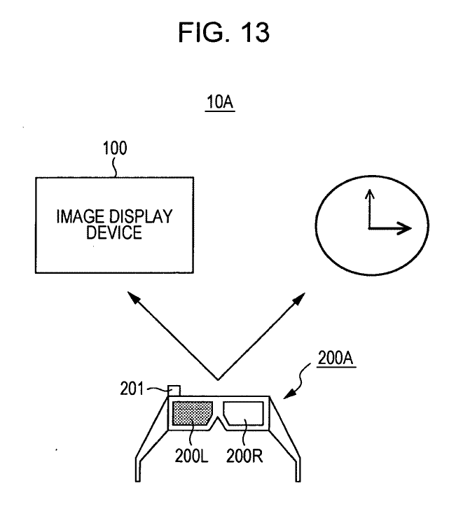

FIG. 13 shows a configuration example of an image display observation system 10A as a second embodiment. In FIG. 13, portions corresponding to FIG. 1 are denoted by the same symbols, whereby the detailed description thereof will be omitted.

The image display observation system 10A includes the image display device 100 and the shutter glasses 200A. The image display device 100 displays the left eye image and the right eye image having parallax in a predetermined period and the time-sharing manner. The image display device 100 is configured as shown in FIG. 2 for example.

The shutter glasses 200A include the position/direction sensor 201. The position/direction sensor 201 detects the position and the direction of the shutter glasses 200A, and obtains the positional information and the directional information as the glasses state information. Although the detailed description is omitted, the shutter glasses 200A are configured in the same manner as the shutter glasses 200 shown in the FIG. 3.

Regarding the image display observation system 10A shown in FIG. 13, a case where the user (observer) wears the shutter glasses 200A and observes the image display device 100 will be described. In this case, based on the positional information and the directional information obtained by the position/direction sensor 201, the shutter glasses 200A perform wireless communication with the image display device 100 and obtain the shutter control signal from the image display device 100.

Based on the shutter control signal, the left eye shutter 200L and the right eye shutter 200R of the shutter glasses 200A are opened and closed according to the display of left eye image and the right eye image on the image display device 100. That is, the left eye shutter 200L of the shutter glasses 200A is opened at the timing when the left eye image is displayed on the image display device 100, and the right eye shutter 200R is opened at the timing when the right eye image is displayed on the image display device 100. Therefore, the user can perceive only the left eye image with the left eye, and only the right eye image with the right eye. Based on the left eye image and the right eye image having parallax and displayed on the image display device 100, the user can perceive the three-dimensional image.

Regarding the image display observation system 10A shown in FIG. 13, a case where the user turns away their gaze from the image display device 100 with the shutter glasses 200 on, and sees the object such as a timepiece around them will be described. In this case, based on the positional information and the directional information obtained by the position/direction sensor 201, both the left eye shutter 200L and the right eye shutter 200R of the shutter glasses unit in the shutter glasses 200A are put in the completely opening state. Accordingly, the user can easily see the objects around them even with the shutter glasses 200A on.

### [Operation of Shutter Glasses]

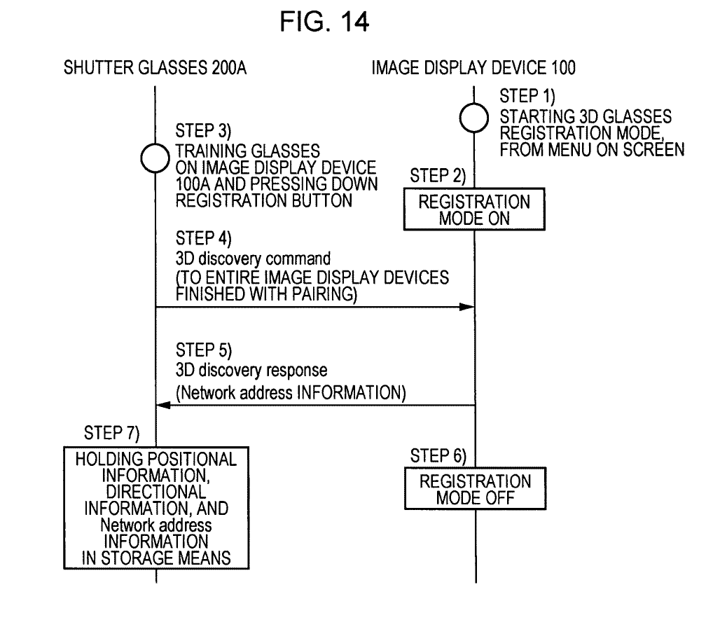

The operation of the shutter glasses 200A will be described. First, the operation performed to hold the information in the storage unit 203a (refer to FIG. 3) will be described. This operation is performed under the control of the control unit 203. FIG. 14 shows an example of a registration sequence. The registration sequence example is the example in a case where the network address information of the image display device 100 is combined with the positional information and the directional information obtained by the position/direction sensor 201, and then held into the storage unit 203a.

In step 1, the user performs the operation to start the 3D glasses registration mode, from the menu on the screen of the image display device 100. In step 2, the registration mode is “ON” in the image display device 100. Next, in step 3, in the observation position, the user trains the shutter glasses 200A on the image display device 100, and presses down the registration button in the user operation unit 202. When the registration button is pressed down, in step 4, the shutter glasses 200A transmit the discovery command (3D discovery command) to all image display devices finished with pairing, through the wireless communication unit 204. Herein, the image display devices finished with pairing are the image display device 100, so the discovery command is transmitted thereto.

Since the registration mode is “ON” in the image display device 100, in step 5, the image display device 100 returns the discovery response (3D discovery response) to the shutter glasses 200A, in response to the transmission of the discovery command. The discovery response contains the network address information of the image display device 100. In step 6, after the discovery response is returned, the registration mode becomes “OFF” in the image display device 100. In step 7, the shutter glasses 200A combine the network address information of the image display device 100 with the positional information and the directional information obtained by the position/direction sensor 201, and hold the combination in the storage unit 203a.

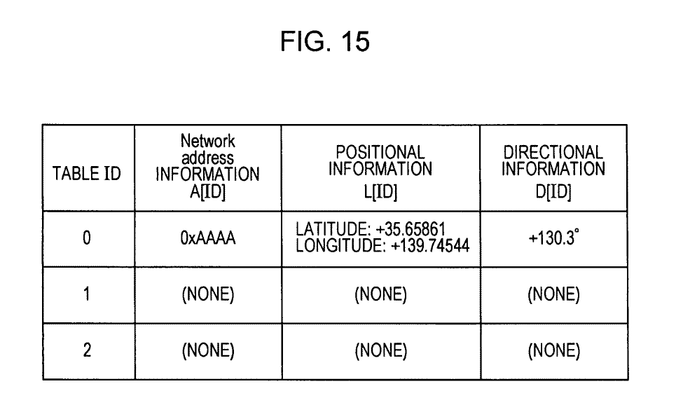

FIG. 15 shows an example of the information management of the storage unit 203a. In the information management example, one combination is held. For instance, the combination represented by Table ID=0 has the network address information A[ID] of “0xAAAA”, the positional information L[ID] of “latitude:+3565861” and “longitude:+139.74544”, and the directional information D[ID] of “+130.3°”.

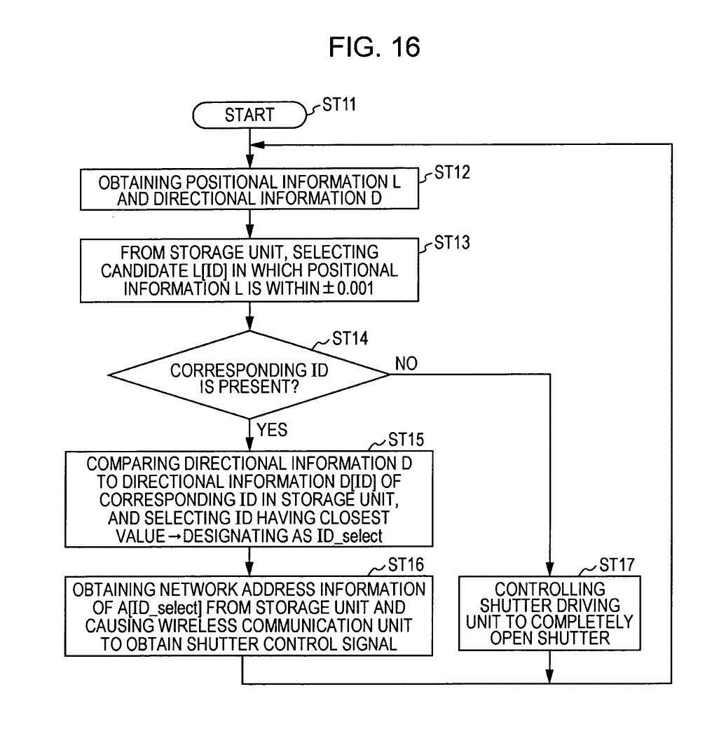

Next, the operation for obtaining the shutter control signal will be described. The operation is performed under the control of the control unit 203. The flowchart in FIG. 16 shows an example of the sequence of a control process of the control unit 203. In step ST11, the control unit 203 starts the control process. For example, when the power becomes “ON” in the shutter glasses 200A, the control process is started.

In step ST12, the control unit 203 obtains the positional information L and the directional information D from the position/direction sensor 201. In step ST13, the control unit 203 selects a candidate L[ID] in which the positional information L is within ±0.001 by the in the storage unit 203a. Thereafter, in step ST14, the control unit 203 determines whether there is a corresponding ID (combination).

When there is no corresponding ID, the control unit 203 returns to the process in the step ST17. In step ST17, the storage unit control unit 203 controls the shutter driving unit 205 to make the completely opening state where both the left eye shutter 200L and the right eye shutter 200R are opened. After the process in step ST17, the control unit 203 returns to the process in step ST12.

When there is a corresponding ID in step ST14, the control unit 203 compares the directional information D to the directional information of the corresponding ID in the storage unit 203a, selects the ID having a close value, and designates it as ID_select, in step ST15. In step ST16, the control unit 203 obtains the network address information of A[ID_select] from the storage unit 203a. Moreover, in the step ST16, the control unit 203 controls the wireless communication unit 204 to obtain the shutter control signal from the corresponding image display device by the network address information of A[ID_select]. After the process in step ST16, the control unit 203 returns to the process in step ST12.

In the control process in the flowchart of FIG. 16, it is thought that there is a case where the user wears the shutter glasses 200A and turns their gaze to the image display device 100 in the observation position. In this case, the network address information of the image display device 100 is obtained as A[ID_select]. Accordingly, the wireless communication unit 204 performs the wireless communication with the image display device 100, and obtains the shutter control signal from the image display device 100.

In the control process in the flowchart of FIG. 16, it is also thought that there is a case where the user turns away their gaze from the image display device 100 with the shutter glasses 200A on and sees the objects around them. In this case, since there is no corresponding ID in step ST14, both the left eye shutter 200L and the right eye shutter 200R are completely opened in step ST17 without obtaining the shutter control signal from the image display device 100.

In the shutter glasses 200A, the shutter control signal obtained by the wireless communication unit 204 is supplied to the shutter driving unit 205 (refer to FIG. 3). Based on the shutter control signal, the shutter driving unit 205 drives the left eye shutter 200L and the right eye shutter 200R constituting the glasses unit 206.

When the user wearing the shutter glasses 200A turns their gaze to the image display device 100 in the observation position, the wireless communication unit 204 obtains the shutter control signal transmitted from the image display device 100, as described above. Therefore, the left eye shutter 200L and the right eye shutter 200R of the glasses unit 206 are opened and closed according to the display of the left eye image and the right eye image of the image display device 100. That is, the Left eye shutter 200L is opened at the timing when the left eye image is displayed on the image display device 100, and the right eye shutter 200R is opened at the timing when the right eye image is displayed on the image display device 100. Accordingly, the user can perceive only the left eye image with the left eye, and only the right eye image with the right eye, and also, based on the left eye image and the right eye image having parallax and displayed on the image display device 100, the user can perceive the three-dimensional image.

Also, when the user (observer) turns away their gaze from the image display device 100 with the shutter glasses 200 on and sees the objects around them such as a timepiece, the wireless communication unit 204 does not obtain the shutter control signal transmitted from the image display device 100 as described above. In this case, both the left eye shutter 200L and the right eye shutter 200R of the glasses unit 206 are completely opened. Therefore, the user can easily see the objects around them even when they are still wearing the shutter glasses 200A.

In the image display observation system 10A shown in FIG. 13 above, when the user turns away their gaze from the image display device 100, shutter control is not continued in synchronization with the image display device 100, and both the left eye shutter 200L and the right eye shutter 200R are completely opened. Accordingly, the user can easily see the objects around them.

### 3. Modification

In the above described embodiments, the image display observation system 10 of FIG. 1 includes two image display devices 100A and 100B, and the image display observation system 10A of FIG. 13 includes one image display device 100. However, the number of image display devices is not limited thereto, and the invention can also be applied to the image display observation system including more image display devices in the same manner.

In addition, in the above described embodiments, the shutter glasses 200 and 200A include the position/direction sensor 201, and use the positional information and the directional information obtained by the position/direction sensor 201 (refer to FIGS. 6 and 16). However, a configuration in which one of a position sensor and a direction sensor is included, and the shutter control signal obtaining process is performed based on one of the positional information or the directional information can also be considered.

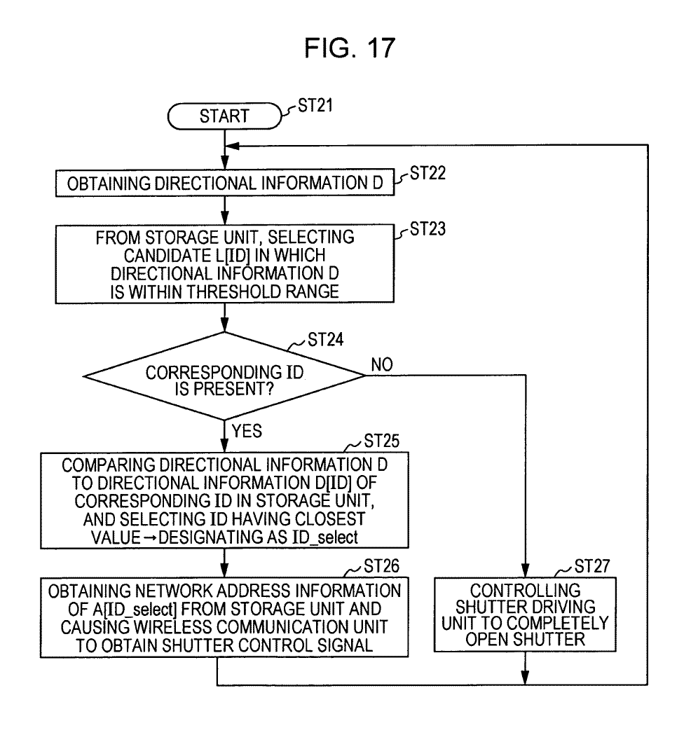

For example, the flowchart in FIG. 17 shows an example of a sequence in which the control unit 203 performs the control process of obtaining the shutter control signal by using the directional information. In this case, in the image display observation system 10A shown in FIG. 13, the shutter glasses 200A include a direction sensor 201D. The control unit 203 starts the control process in step ST21. The control process is started when the power becomes “ON” in the shutter glasses 200A for example.

Next, the control unit 203 obtains the directional information D from the direction sensor 201D in step ST22. In step ST23, the control unit 203 selects a candidate D[ID] in which the directional information D is within a predetermined threshold range, from the storage unit 203a. Thereafter, in step ST24, the control unit 203 determines whether there is a corresponding ID (combination).

When there is no corresponding ID, the control unit 203 returns to the process in step ST27. In the step ST27, the control unit 203 controls the shutter driving unit 205 so that both the left eye shutter 200L and the right eye shutter 200R are completely opened. After the process in the step ST27, the control unit 203 returns to the process in step ST22.

When there is a corresponding ID in step ST24, the control unit 203 compares the directional information D to the directional information of the corresponding ID in the storage unit 203a, selects the ID having a close value, and designates it as ID_select, in step ST25. In step ST26, the control unit 203 obtains the network address information of A[ID_select] from the storage unit 203a. Moreover, in the step ST26, the control unit 203 controls the wireless communication unit 204 to obtain the shutter control signal from the corresponding image display device by the network address information of A[ID_select]. After the process in step ST26, the control unit 203 returns to the process in step ST22.

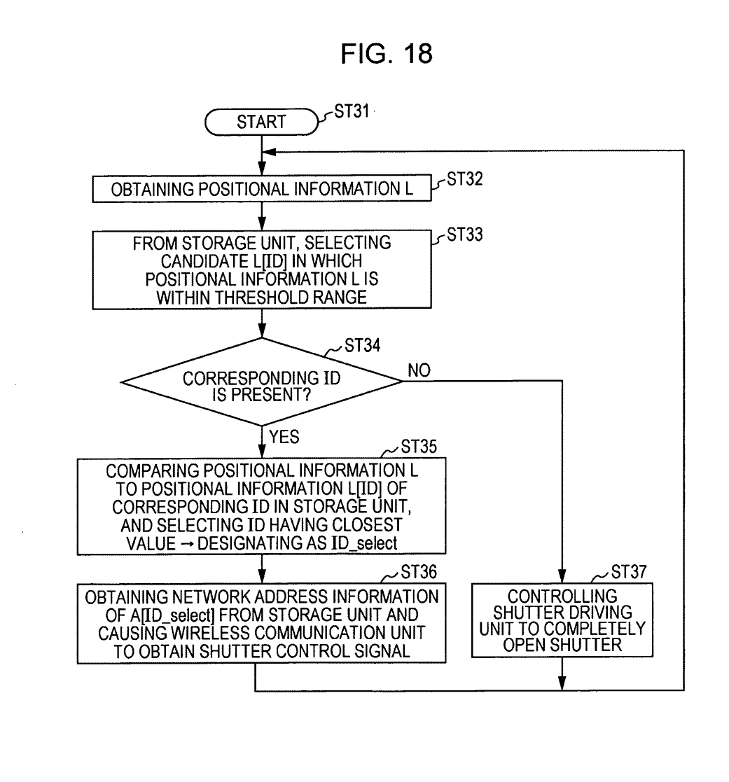

For example, the flowchart in FIG. 18 shows an example of a sequence in which the control unit 203 performs the control process of obtaining the shutter control signal by using the positional information. In this case, in the image display observation system 10A shown in FIG. 13, the shutter glasses 200A include a position sensor 201L. The control unit 203 starts the control process in step ST31. The control process is started when the power becomes on in the shutter glasses 200A for example.

Next, the control unit 203 obtains the positional information L from the position sensor 201L in step ST32. In step ST33, the control unit 203 selects a candidate L[ID] in which the positional information L is within a predetermined threshold range, from the storage unit 203a. Thereafter, in step ST34, the control unit 203 determines whether there is a corresponding ID (combination).

When there is no corresponding ID, the control unit 203 returns to the process in step ST37. In the step ST37, the control unit 203 controls the shutter driving unit 205 so that both the left eye shutter 200L and the right eye shutter 200R are completely opened. After the process in the step ST37, the control unit 203 returns to the process in step ST32.

When there is a corresponding ID in step ST34, the control unit 203 compares the positional information L to the positional information of the corresponding ID in the storage unit 203a, selects the ID having a close value, and designates it as ID_select, in step ST35. In step ST36, the control unit 203 obtains the network address information of A[ID_select] from the storage unit 203a. Moreover, in the step ST36, the control unit 203 controls the wireless communication unit 204 to obtain the shutter control signal from the corresponding image display device by the network address information of A[ID_select]. After the process in step ST36, the control unit 203 returns to the process in step ST32.

Even when the processes shown in FIGS. 17 and 18 described above are performed, an image display device from which the shutter control signal is supposed to be obtained is specified, based on the glasses state (positional and directional state). Accordingly, when there is a plurality of image display devices, if a user turns their gaze off the specific image display device to another image display device, another image display device is automatically specified as the image display device from which the shutter control signal is supposed to be obtained, and the shutter control signal is obtained from the other image display device. Therefore, it is not necessary for the user to select and switch the image display device themselves, whereby the usability is improved.

Even when the processes shown in FIGS. 17 and 18 described above are performed, in a case where the user changes the observation direction and position and turns away their gaze from a specific image display device, both the left eye shutter and the right eye shutter are completely opened. Therefore, the user can easily see the objects around them even with the shutter glasses on.

The invention is not limited to the above embodiments and modification. It should be understood by those skilled in the art that various modifications and alterations may occur within the scope of the appended claims or the equivalents thereof; therefore, the modifications and alterations of course belong to the technical scope of invention.

What is claimed is:

1. A pair of shutter glasses comprising:
a shutter glasses unit having a right eye shutter and a left eye shutter;
a wireless communication unit performing a wireless communication with an image display device carrying out a time-sharing display of a left eye image and a right eye image in a predetermined period;
a shutter driving unit opening and closing the left eye shutter and the right eye shutter of the shutter glasses unit based on the shutter control signal obtained from the image display device by the wireless communication unit;
a glasses state obtaining unit obtaining glasses state information by detecting one or both of a position and a direction of the shutter glasses unit as a glasses state;
a storage unit holding a combination of the glasses state information and network address information of the image display device; and
a control unit causing the wireless communication unit, when the storage unit has a combination containing glasses state information corresponding to the glasses state information which is obtained by the glasses state obtaining unit, to perform the wireless communication with a predetermined image display device using the network address information contained in the combination, and to obtain the shutter control signal from the predetermined image display device accordingly.

2. The shutter glasses according to claim 1,
wherein the glasses state obtaining unit detects one or both of the position and the direction of the shutter glasses unit as a glasses state, thereby obtaining positional information and directional information,
the storage unit holds a combination of the positional and directional information and the network address information, and
the control unit causes the wireless communication unit, when the storage unit has a predetermined number of combinations containing the positional information within a predetermined threshold range with respect to the positional information obtained by the glasses state obtaining unit, to perform the wireless communication with a predetermined image display device, using the network address information contained in a combination containing the directional information closest to the directional information obtained by the glasses state obtaining unit, among the predetermined number of combinations, and to obtain the shutter control signal from the predetermined image display device accordingly.

3. The shutter glasses according to claim 1, further comprising:
a registration unit in the storage unit, for causing the storage unit to hold a combination of glasses information and the network address information,
wherein the registration unit has a user operation unit for the user to perform a registration operation, and when the registration operation is performed in the user operation unit, the registration unit causes the wireless communication unit to transmit a discovery command to all the image display device finished with pairing and to receive a discovery response from a predetermined image display device, in response to the transmission of the discovery command, and causes the storage unit to hold the combination of the network address information of the predetermined image display device contained in the discovery response and the glasses state information obtained by the glasses state obtaining unit.

4. The shutter glasses according to claim 1,
wherein, when the storage unit does not have the combination containing the glasses information corresponding to the glasses state obtained by the glasses state obtaining unit, the control unit causes the shutter driving unit to make a completely open state where both the left eye shutter and the right eye shutter of the shutter glasses are opened.

5. The shutter glasses according to claim 4,
wherein the glasses state obtaining unit detects both the position and the direction of the shutter glasses unit as a glasses state to obtain the positional information and the directional information,
the storage unit holds the combination of the positional and directional information and the network address information, and
when the storage unit does not have a combination containing the positional information within a predetermined threshold range with respect to the positional information obtained by the glasses state obtaining unit, the control unit causes the shutter driving unit to make the completely open state where both the left eye shutter and the right eye shutter of the shutter glasses are opened.

6. The shutter glasses according to claim 1,
wherein the wireless communication unit has an opening/closing counter used for opening and closing the left eye shutter and the right eye shutter of the shutter glasses unit, requests the image display device for the synchronization of clock frequency, matches the value of the opening/closing counter with the value of a counter in the image display device, which is counted by the synchronized clock frequency, and periodically receives a shutter opening/closing timing from the image display device as the shutter control signal, in response to the value of the opening/closing counter.

7. A method of obtaining a shutter control signal of a pair of shutter glasses including a shutter glasses unit having a left eye shutter and a right eye shutter, a wireless communication unit performing a wireless communication with an image display device carrying out a time-sharing display of a left eye image and a right eye image in a predetermined period, and a shutter driving unit opening and closing the left eye shutter and the right eye shutter of the shutter glasses unit based on the shutter control signal obtained from the image display device by the wireless communication unit, the method comprising the steps of:
holding a combination of glasses state information and network address information of an image display device in a storage unit;
obtaining state information by detecting one or both of the position and the direction of the shutter glasses unit as a glasses state; and
when the storage unit has a combination containing glasses state information corresponding to the glasses state information which is obtained in the step of obtaining state information, performing the wireless communication with a predetermined image display device using the network address information contained in the combination, and to obtain the shutter control signal from the predetermined image display device accordingly.
